(19) United States
(12) Patent Application Publication
(10) Pub. No.: US 2007/0062498 A1
(43) Pub. Date: Mar. 22, 2007

(54) Supercharger gear drive system

(76) Inventor: Terrill Wayne Woods, Sierra Vista, AZ (US)

Correspondence Address: Terrill Wayne Woods, 2302 Piccadilly Dr., Sierra Vista, AZ, 85635-5012, US

(21) Appl. No.: 11/232,296

(22) Filed: Sep. 21, 2005

(51) Int. Cl. F02B 33/00

(52) U.S. Cl. 123/559.1

(57) ABSTRACT

The invention relates generally to a drive mechanism for superchargers on internal combustion engines. More particularly, the present invention concerns a gear drive which totally eliminates the need for a belt or chain to drive the supercharger. An important object of the present invention is to provide a robust and reliable gear drive which is simple and adaptable. This allows presently available standardized mass produced superchargers to be mounted to and driven by the crankshaft of a variety of engine families thereby totally eliminating the need for a belt in the drive system. A second object of the present invention is to minimize costs by replacing the presently used belts and pulleys with additional gears internal to and integral with the supercharger housing thereby allowing the supercharger input shaft to be driven directly from the engine crankshaft.

### CROSS REFERENCE

References Cited
U.S. PATENT DOCUMENTS

| | | |
|---|---|---|
| 6,568,376 | 5/2003 | Sonnleitner |
| 6,516,788 | 2/2003 | Roderique |
| 6,609,505 | 8/2003 | Janson |
| 6,308,693 | 10/2001 | Lee |
| 6,192,871 | 2/2001 | Middlebrook |
| 6,082,340 | 7/2000 | Heimark |
| 5,289,813 | 3/1994 | Adachi, et al. |
| 5,133,325 | 7/1992 | Winkelmann |
| 4,671,137 | 6/1987 | Di Aragona |
| 4,519,373 | 5/1985 | Hardy, et al. |

### FEDERALLY SPONSORED RESEARCH OR DEVELOPMENT

Not Applicable

### SEQUENCE LISTING, A TABLE OR A COMPUTER PROGRAM LISTING COMPACT DISC APPENDIX

Not Applicable

### BACKGROUND OF THE INVENTION

1. Field of the Invention

The present invention relates to a supercharged internal combustion engine.

2. Description of Related Art

Supercharging of internal combustion engines (henceforth referred to as engine) is a well established method of obtaining greater power output from engines of a given size. Supercharging allows relatively small and lightweight engines to produce power equal to or greater than larger and heavier naturally aspirated engines. In many forms of automotive and marine racing this can be a significant advantage.

Drive mechanisms for superchargers generally fall into one of two categories, either an exhaust turbine driving a centrifugal compressor, commonly called a turbocharger, or a roots, screw, axial or centrifugal compressor powered from the engine crankshaft commonly called superchargers.

When properly matched and optimized to an engine, turbochargers produce the highest specific power output and lowest specific fuel consumption of all known types of superchargers. This is due to the fact turbochargers capture what would otherwise be wasted energy and use it to power the compression of the engine intake air.

The primary problem with turbocharging is the difficulty of properly matching the turbine and compressor to each particular engine in such a way as to achieve the desired performance over the engines full range of operating conditions. In practice this has required the integration of several sub-systems, some of which must work reliably while controlling exhaust gases at extremely high temperatures. Examples of these sub-systems include variable inlet geometry for the turbine to combat turbo lag, and exhaust wastegates to obtain low speed boost without the problem of over-boosting at higher engine speeds. The end result is turbocharger systems become so complex they do not achieve the desired cost and reliability objectives and therefore a more simple and reliable mechanically driven supercharger system is utilized.

Mechanically driven supercharger systems can be studied in greater detail in two distinct categories. First is the engine or application specific integrated drive systems and the second type is the flexible and adaptable non-integrated belt drive system.

Engine or application specific supercharger drive systems have taken many forms. Examples include a direct drive from the camshaft as disclosed in U.S. Pat. No. 6,308,693 to Lee. The problem with Lee's (U.S. Pat. No. 6,308,693) integrated camshaft driven supercharger is the fact it requires a specifically designed engine with a unique camshaft drive and therefore does not apply to the present embodiment which allows superchargers to be mounted to and driven by a variety of standard engines.

A second example of an engine or application specific integrated supercharger drive system is disclosed in U.S. Pat. No., 6,568,376 to Sonnleitner. Sonnleitner (U.S. Pat. No., 6,568,376) integrated a supercharger drive into a power take-off housing including the air intake plenum, the engine starting system and gears to drive a balance shaft for the engine and a generator. This was done in order to create a very compact and powerful in-line engine for a personal watercraft. The problem with the highly integrated approach is in practice automotive and marine fabricators employ many different makes and models (types) of superchargers and many different makes and models of engines. The present embodiment addresses the flexibility and adaptability required to meet automotive and marine fabrication needs.

Further examples of highly integrated supercharge drive systems include two speed supercharger drives disclosed in U.S. Pat. Nos., 5,133,325 to Winkelmann; U.S. Pat. No. 5,289,813 to Adachi, et al; and U.S. Pat. No. 6,609,505 to Janson. Winkelmann (U.S. Pat. No. 5,133,325) disclosed a two speed supercharger drive with electromagnetically activated separating clutch and a planetary gearset to allow a step up ratio to the supercharger during periods of heavy load at low engine speed and shiftable back to crankshaft speeds at lighter loads or higher engine speeds. This step up ratio at low engine speeds is not considered in the present embodiment as high loads at low engine speeds are not a factor in racing since engine speeds during competition are maintained at high levels.

A second highly integrated two speed supercharger drive system is disclosed by Adachi (U.S. Pat. No. 5,289,813) and used a first, second and third shaft, a first and second timing gear for a first and second rotor, a first and second pulley, an electromagnetic clutch, a one way clutch and a belt to create two supercharger drive speeds. The major disadvantage of Adachi's (U.S. Pat. No. 5,289,813) two speed drive as compared to the present embodiment is the weakness of the belt and resulting unacceptably high failure rate under racing conditions.

A third two speed drive system is disclosed by Janson (U.S. Pat. No. 6,609,505). Janson (U.S. Pat. No. 6,609,505) disclosed, “A supercharger system for an internal combustion engine that includes a two speed gearbox between the drive pulley on the engine and the driven pulley on the compressor.” “The gear box includes two planetary gear sets (54, 70) and a controllable clutch (66).” Janson (U.S. Pat. No. 6,609,505) maintained flexibility and adaptability through the use of a belt drive in conjunction with the two speed drive. Again the weakness is the belt under conditions such as racing or high performance automotive and marine applications produce.

Neither of the two speed drives either by Adachi (U.S. Pat. No. 5,289,813) or Janson (U.S. Pat. No. 6,609,505) are considered practical for racing as both employ belts in the drive. As stated earlier racing conditions impose higher impact loads than belts can reliably handle and thus the need for the present Supercharger Gear Drive System invention.

U.S. Pat. No., 4,671,137 to Di Aragona discloses a hydrostatic pump and motor integrated into a variable speed drive for a supercharger. The hydrostatic variable speed drive for a supercharger is not practical (although novel) in racing or high performance automotive applications due to its high cost, high complexity and low efficiency.

The last example of highly integrated supercharger drive system is disclosed by Hardy U.S. Pat. No., 4,519,373. Hardy (U.S. Pat. No., 4,519,373) discloses an electro-magnetically variably engagable slipping clutch for a variable speed roots type supercharger drive system. Again this becomes an integrated system specific to one supercharger and requires integration with the engine cooling system for clutch cooling and integration into the engine power output shaft for speed and load sensing. This again is problematic for fabricators who need a design which is readily usable on many different superchargers and many different engines as is commonplace in racing and high performance automotive and marine applications. An additional limitation is, the slipping wet clutch is belt driven from the crankshaft and carries the previously mentioned weakness of the belt drive.

Moving away from the highly integrated supercharger drive systems brings us to the most common supercharger drive system in practice today. This system is typified by a simple and adaptable belt drive from the engine crankshaft to the input shaft of a supercharger. This drive system has several advantages. It is the most simple, is readily adaptable to many different superchargers and different engine families and it allows manufacturers of superchargers to market a family of standardized superchargers to customers with a broad range of different engines. This type of supercharger drive system is broadly applied as referenced in U.S. Pat. No. 6,516,788 by Roderique, U.S. Pat. No., 6,082,340 by Heimark and U.S. Pat. No., 6,192,871 by Middlebrook.

As mentioned previously problems with the belt drive from the crankshaft to the supercharger input shaft come when the applications are severe. Automotive racing and other forms of high performance automotive and marine applications expose a supercharger drive system to extremely high speeds and extremely rapid changes in speed and this takes belt drives beyond their present capabilities for both speed and load. The resultant loss of reliability in these applications leads to the need for the present invention.

### SUMMARY OF THE INVENTION

In accordance with the present invention the SUPERCHARGER GEAR DRIVE SYSTEM provides high reliability, low maintenance, low noise, and high levels of shock and vibration isolation, while supporting a wide variety of existing superchargers and existing internal combustion engines at minimal manufacturing effort and cost.

The crankshaft driven gear-drive engine systems are common knowledge and widely used. Supercharged engine systems are heavily utilized in the piston-driven aircraft, and heavy industrial and heavy marine industries. However, the unique challenges of a practical design for automotive applications have eluded design engineers up to the present invention. The SUPERCHARGER GEAR DRIVE SYSTEM invention has successfully resolved the unique to automotive challenge of extremely limited space, broad adaptability to fit many different engines and option packages while providing low noise, and shock and vibration isolation more commonly associated with belt-driven systems. In effect, this invention provides the commonly known advantages of high reliability and low maintenance of a crankshaft gear-driven system while also providing the advantages of low noise and shock and vibration isolation of a belt-drive system. An additional advantage of this invention is the large side load applied to the engine crankshaft and the supercharger input shaft common to belt-driven systems is totally eliminated thereby significantly increasing the reliability of both the engine and the supercharger. In addition the present invention addresses the adaptability to support a variety of superchargers, engines and engine packages at minimal manufacturing cost and effort.

Although the description above contains many specifications, these should not be construed as limiting the scope of the invention but as merely providing illustrations of some of the presently preferred embodiments of this invention.

Thus the scope of the invention should be determined by the appended claims and their legal equivalents, rather than by the examples given.

In response to the aforementioned problems with belt driven supercharger systems in automotive racing and other high performance automotive and marine applications an important object of the present invention is to provide a robust and reliable gear drive which is simple and adaptable. This allows presently available standardized mass produced superchargers to be mounted to and driven by the crankshaft of a variety of engine families thereby totally eliminating the need for a belt in the drive system.

A second object of the present invention is to minimize costs by replacing the presently used belts and pulleys with additional gears internal to and integral with the supercharger housing thereby allowing the supercharger input shaft to be driven directly from the engine crankshaft.

The present embodiment and drawings disclose and detail five adaptations of a supercharger gear drive system which achieve the above mentioned goals.

The first adaptation uses presently available mass produced standard rotation standard helix superchargers (i.e., input shaft rotates clockwise when viewed from the front of the supercharger input shaft) (hereto referred to as a standard rotation, standard helix compressor), which commonly have a integral single gear mesh transmission and are commonly mounted alongside or above the engine. In the present embodiment the supercharger is turned 180° (degrees) on a horizontal plane so the supercharger input shaft which commonly faces away from the engine now faces the engine and replaces the belt and pulleys with a single gear mesh gearbox mounted between the engine crankshaft and the supercharger input shaft. The single gear mesh gearbox reverses the crankshaft rotation and compensates for turning the supercharger input shaft 180° (degrees) and the standard helix supercharger rotates in the correct direction and the belt drive is eliminated. (See FIG. 2).

The second adaptation also uses the standard rotation, standard helix compressor but places the additional single gear mesh inside the supercharger transmission housing making the supercharger transmission a two gear mesh transmission. The supercharger input shaft then is driven directly from the engine crankshaft. This solution also eliminates any need for a belt to drive the supercharger and eliminates the external single gear mesh gearbox as compared to the first adaptation. This is the favored solution for low cost with a standard rotation standard helix compressor. It does however require a new design of the supercharger transmission. (See FIG. 3).

The third adaptation uses the presently mass produced reverse rotation reverse helix supercharger (i.e., the input shaft rotates counterclockwise when viewed from the front of the supercharger input shaft) (hereto referred to as a reverse rotation reverse helix compressor), with its integral single gear mesh transmission and simply replaces the belt and pulleys with a two gear mesh gearbox mounted between the engine crankshaft and supercharger input shaft. Again the rotation of the supercharger is correct and the belt drive is eliminated. (See FIG. 4).

The fourth adaptation uses the presently mass produced reverse rotation reverse helix supercharger as above and eliminates the belt and pulleys by mounting the supercharger so the input shaft is driven directly from the engine crankshaft. This adaptation applies when the supercharger capacity meets the needs of the engine with the supercharger input shaft driven at engine crankshaft speed. (See FIG. 5).

The fifth adaptation uses a reverse rotation reverse helix compressor and adds a two gear mesh transmission integral to the supercharger housing making it a three gear mesh transmission and drives the supercharger directly from the engine crankshaft.

All five of the above adaptations incorporate harmonic vibration isolators in a coupling between the engine crankshaft and the gearbox and also in a coupling between the gearbox and the supercharger input shaft. (See FIG. 6).

### OBJECTS AND ADAVANTAGES

Accordingly, several objects and advantages of my SUPERCHARGER GEAR DRIVE SYSTEM invention are:
a) to provide a gear-driven crankshaft drive with improved design to support a variety of engine types, styles and manufacturers;
b) to provide a gear-driven crankshaft drive with improved functionality to support a variety of engine types, styles and manufacturers;
c) a gear-driven crankshaft drive to support heavy duty utilization of the engine (such as a supercharged engine);
d) a gear-driven crankshaft drive that successfully and creatively utilize the limited space available to a crankshaft drive in a standard engine compartment;
e) a gear-driven crankshaft drive to support a variety of engine option packages (such as air-conditioning and power steering) with no or minimal modifications to the basic design;
f) a gear-driven crankshaft drive to provide low noise during engine operation;
g) a gear-driven crankshaft drive to provide shock and vibration isolation during engine operation;
h) a gear-driven crankshaft drive to provide high reliability with engine use;
i) a gear-driven crankshaft drive to provide low maintenance with engine use;
j) a gear-driven crankshaft drive to support a variety of engine supercharger systems;
k) improvement over belt-driven crankshaft drives because the design eliminates the belt resulting in higher reliability and lower maintenance;
l) improvement over chain-driven crankshaft drives because the design eliminates the chain resulting in higher reliability and lower maintenance;
m) improvement over current gear-driven crankshaft drives because the design supports a variety of engine types and option packages, reduces noise and reduces the shock and vibration issues.

### BRIEF DESCRIPTION OF THE DRAWINGS

FIG. 1 is a three-quarter front elevational view of a typical supercharged engine with a standard rotation belt driven, centrifugal compressor supercharger. The supercharger has a single gear mesh transmission integral to the supercharger housing which is the most common configuration. A deviation not shown would be a belt driven standard rotation roots or screw compressor supercharger normally mounted directly on top of the engine via an intake manifold. The only difference in these two would be the type of compressor being belt driven by the crankshaft.

FIG. 2 is a three-quarter front elevational view of a supercharged engine with a self contained single gear mesh crankshaft drive in conjunction with a standard rotation centrifugal compressor. Note the supercharger has been turned 180° (degrees) on a horizontal plane as compared to its belt drive position on the engine. The supercharger has a single gear mesh transmission integral to the supercharger housing which is the most common configuration. An allowable deviation not shown would be a self contained single gear mesh drive in conjunction with a standard rotation Roots or screw compressor supercharger. Again the supercharger would be turned 180° (degrees) on a horizontal plane as compared to its belt drive position on the engine.

FIG. 3 is a three-quarter front elevational view of a supercharged engine with a direct crankshaft driven standard rotation centrifugal compressor supercharger with an integral two gear mesh transmission replacing the normal single gear mesh transmission integral to the supercharger housing.

FIG. 4 is a three-quarter front elevational view of a supercharged engine with a self contained two gear mesh crankshaft drive in conjunction with a reverse rotation reverse helix centrifugal compressor supercharger. The supercharger has a single gear mesh transmission integral to the supercharger housing which is the most common configuration.

FIG. 5 is a three-quarter front elevational view of a supercharged engine with a direct crankshaft driven reverse rotation reverse helix centrifugal compressor supercharger. The supercharger has a single gear mesh transmission integral to the supercharger housing which is the most common configuration.

FIG. 6 is a cross-sectional view cut through the vertical centerline of a typical single gear mesh self contained crankshaft gear drive as would be applied in claim 1 as shown in FIG. 2. It shows the power flow from the engine crankshaft, through two sets of harmonic vibration isolators to the gear drive, then through two additional sets of harmonic vibration isolators to the supercharger input shaft. Sequential numbers starting with 1 for the engine crankshaft through 15 for the supercharger input shaft trace flow of the engine torque through the gear drive. Engine torque flows from number 1 to number 2 to number 3 to number 4 to number 5 . . . to number 15.

### DETAILED DESCRIPTION OF THE INVENTION

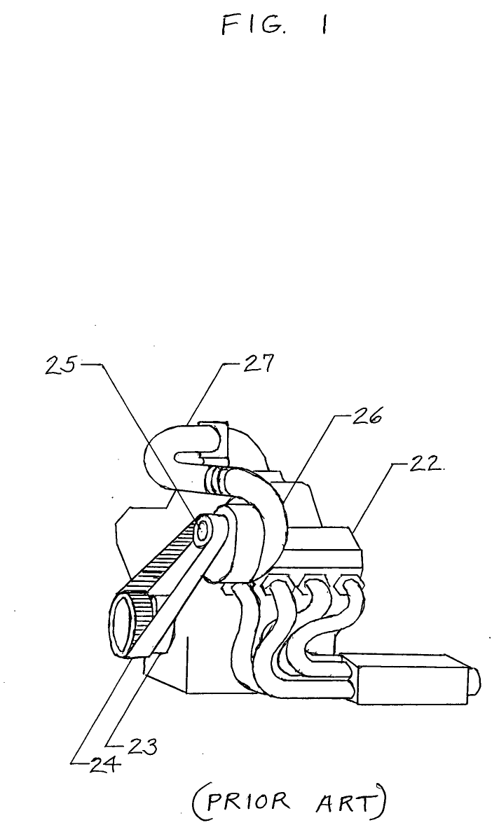

The typical supercharged engine illustrated in FIG. 1 comprises an engine 22 with crankshaft 23 providing engine torque to a belt 24 which transfers said engine torque to a supercharger single gear mesh transmission input shaft 25 which converts engine torque into boost energy via the air compressor 26 for delivery to the engine through an air intake pipe 27.

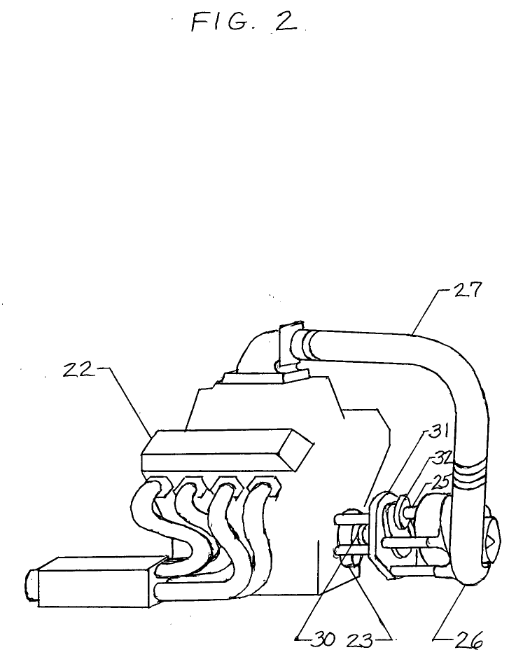

FIG. 2 illustrates claim 1 of the embodiment of the invention, a supercharged engine with a self contained gear drive applied to a standard rotation standard helix supercharger which has been turned 180° (degrees) on a horizontal plane relative to its orientation with a belt drive.

Here an engine 22 with crankshaft 23 provides engine torque to a torsional vibration isolating coupling 30 which provides engine torque to a single gear mesh gear drive 31 which passes the engine torque to an output torsional vibration isolating coupling 32 which passes the engine torque to a supercharger single gear mesh transmission input shaft 25 which converts engine torque into boost energy via the standard rotation standard helix air compressor 26 for delivery to the engine through an air intake pipe 27.

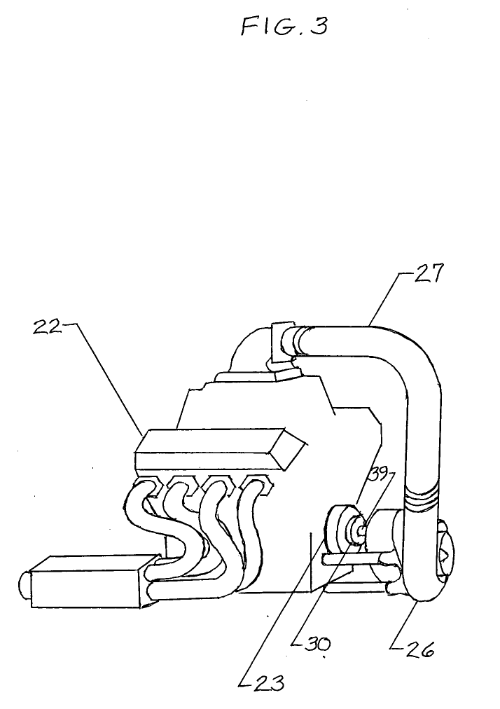

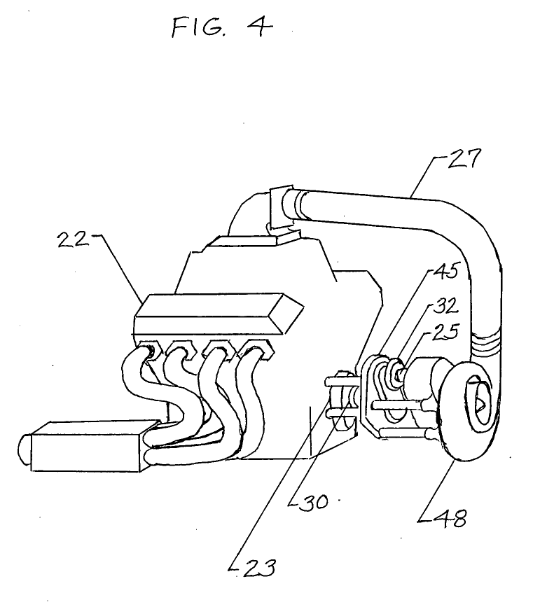

Those knowledgeable and experienced in the art recognize another means of accomplishing the essence of claim 1 as to integrate the single gear mesh transmission into the supercharger transmission housing thereby making it into an integrated two gear mesh transmission. This is claim 2 and is illustrated in FIG. 3. FIG. 3 illustrates a supercharged engine with a two gear mesh transmission integral with a standard rotation standard helix supercharger driven directly by the engine crankshaft.

Here an engine 22 with crankshaft 23 provides engine torque to a torsional vibration isolating coupling 30 which provides engine torque to a supercharger two gear mesh transmission input shaft 39 which converts engine torque into boost energy via the standard rotation standard helix air compressor 26 for delivery to the engine through an air intake pipe 27.

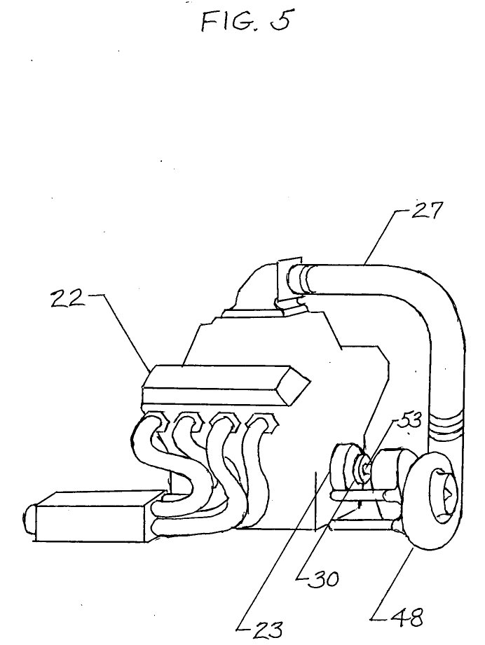

FIG. 4 illustrates claim 3 of the embodiment of the invention, a supercharged engine with a two gear mesh self contained crankshaft gear drive driving a reverse rotation reverse helix supercharger.

Here an engine 22 with crankshaft 23 provides engine torque to a torsional vibration isolating coupling 30 which passes the torque into a two gear mesh self contained gearbox 45 which passes the torque to an output torsional vibration isolating coupling 32 which drives the supercharger single gear mesh transmission input shaft 47 which converts engine torque into boost energy via a reverse helix air compressor 48 for delivery to the engine through an air intake pipe 27.

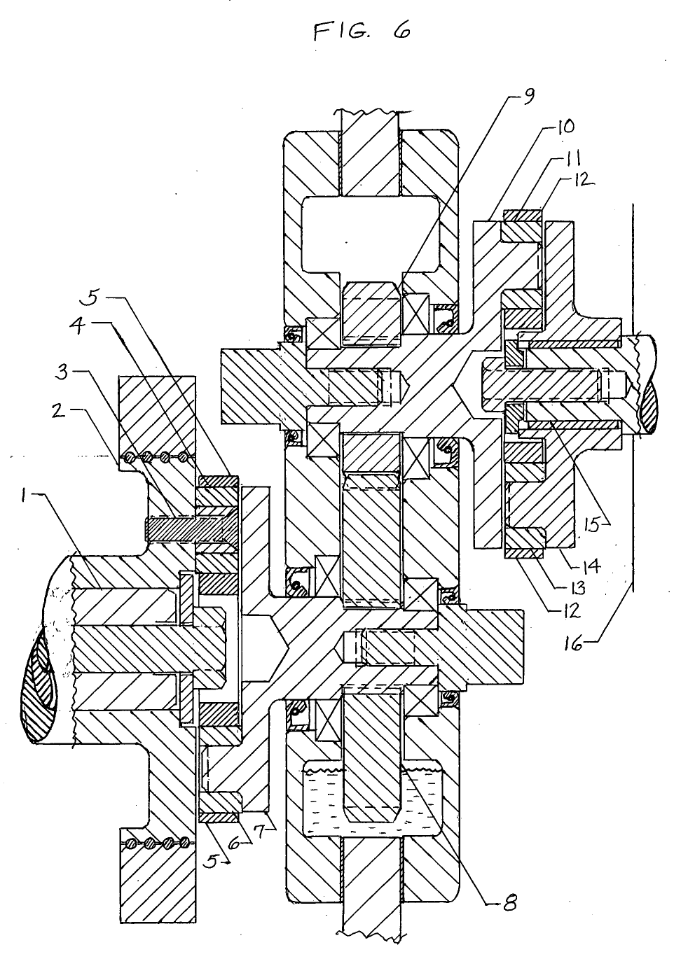

Those knowledgeable and experienced in the art recognize another means of accomplishing the essence of claim 3 as to integrate the two gear mesh transmission into the supercharger transmission housing thereby making it into an integrated three gear mesh transmission. This is claim 4 and is illustrated in FIG. 5. FIG. 5 illustrates a supercharged engine with a three gear mesh transmission integral with a reverse rotation reverse helix supercharger driven directly from the engine crankshaft.

Here an engine 22 with crankshaft 23 provides engine torque to a torsional vibration isolating coupling 30 which passes engine torque to the supercharger three gear mesh transmission input shaft 53 which converts engine torque into boost energy via a reverse rotation reverse helix air compressor 48 for delivery to the engine through an air intake pipe 27.

Those knowledgeable and experienced in the art recognize another means of accomplishing the essence of claim 4 as to simply drive the reverse rotation reverse helix supercharger with its integral single gear mesh transmission directly from the engine crankshaft. This is a practical solution when the reverse rotation reverse helix superchargers input shaft turning at crankshaft speed meets the flow and pressure requirements of the engine on which is it mounted.

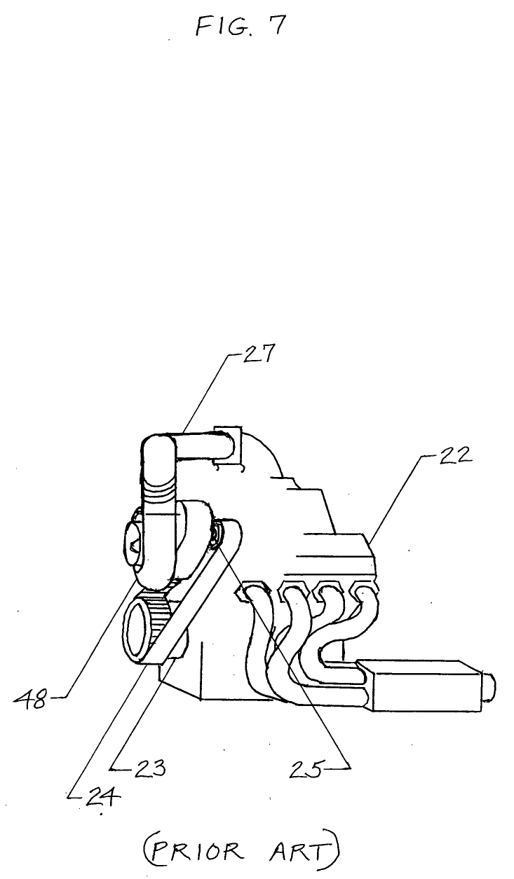

FIG. 6 is a cross-sectional view cut through the vertical centerline of a typical single gear mesh self contained gear drive as utilized in claim 1.

Here (See FIG. 6) an engine crankshaft 1 connected to a harmonic balancer 2 provides engine torque to drive screw 3 which passes the engine torque to vibration isolation cushions 4 which drive the intermediate coupler 5 which drive the vibration isolation cushions 6 which drive the gear drive input shaft 7. The gear drive input shaft is splined into and drives the first gear 8 which drives the second gear 9 which is splined to the output shaft 10. Output shaft 10 passes engine torque to vibration isolation cushions 11 which pass engine torque to the intermediate coupling 12 which passes engine torque to vibration isolation cushions 13 which pass engine torque to the supercharger input shaft coupler which passes engine torque to the supercharger transmission input shaft 15 which converts engine torque into boost energy via an internal single gear mesh transmission which drives an air compressor 16.

I claim:

1. A supercharger of the type which normally uses a belt and pulleys to connect the crankshaft and superchargers input shaft (See FIG. 1) to convert engine torque into boost energy for delivery to the engine in the form of compressed air comprising:
A standard rotation, standard helix compressor means (i.e., input shaft rotates clockwise when viewed from the front of the supercharger input shaft) (hereto referred to as a standard rotation, standard helix compressor), but turned 180° (degrees) on a horizontal plane from its belt drive orientation communicated with a source of air to the engine and rotatably drivable for compressing the air and directing the same towards the engine;
A single gear mesh self-contained crankshaft gear drive communicated with the engine in torque receiving relationship thereto and with the integral single gear mesh transmission of the compressor means to be capable of transmitting said torque to the compressor means and drive the same: (See FIG. 2);

2. A supercharger of the type which convert engine torque into boost energy for delivery to the engine in the form of compressed air comprising:
A standard rotation, standard helix compressor means communicated with a source of air to the engine and rotatably drivable for compressing the air and directing the same towards the engine;
A two gear mesh transmission internal to and integral with the compressor comprising a direct engine crankshaft drive supercharger; (See FIG. 3);

3. A supercharger of the type which normally uses a belt and pulleys to connect the crankshaft and superchargers input shaft (See FIG. 7) to convert engine torque into boost energy for delivery to the engine in the form of compressed air comprising:
A reverse rotation, reverse helix compressor means (i.e., the input shaft rotates counterclockwise when viewed from the front of the supercharger input shaft) (hereto referred to as a reverse rotation reverse helix compressor), communicated with a source of air to the engine and rotatably drivable for compressing the air and directing the same towards the engine;
A two gear mesh self-contained gearbox communicated with the engine in torque receiving relationship thereto and with the single gear mesh transmission of the compressor means to be capable of transmitting said torque to the compressor means and drive the same: (See FIG. 4);

4. A supercharger of the type which convert engine torque into boost energy for delivery to the engine in the form of compressed air comprising:
A reverse rotation, reverse helix compressor means with integral single gear mesh transmission communicated with a source of air to the engine and rotatably drivable for compressing the air and directing the same towards the engine.

5. A supercharger of the type which convert engine torque into boost energy for delivery to the engine in the form of compressed air comprising:
A reverse rotation, reverse helix compressor means communicated with a source of air to the engine and rotatably drivable for compressing the air and directing the same towards the engine;
A three gear mesh transmission internal to and integral with the compressor comprising a direct engine crankshaft drive supercharger; (See FIG. 5).

6. A supercharger crankshaft gear drive system that adapts to at least 6 (six) distinctly different currently existing engine families by changing only two simple single piece engine brackets and one crankshaft drive hub.
A supercharger crankshaft gear drive system that adapts to at least 10 (ten) distinctly different currently existing superchargers by changing only the supercharger bracket and supercharger drive hub.
One gear drive main body, identical in all respects, is used for six engine families and ten superchargers. Each engine family has two simple single piece brackets and one crankshaft hub that attach to the gear drive main body assembly identically. Each supercharger has a bracket and drive hub that attach to the gear drive main body assembly identically. This allows a single gear drive assembly to be manufactured and applied to six engine families and ten superchargers with a minimum of investment and manufacturing costs.
